(19) United States
(12) Patent Application Publication
(10) Pub. No.: US 2011/0209786 A1
(43) Pub. Date: Sep. 1, 2011

(54) Vessel Compressor Methods and Systems

(76) Inventors: Peter C. Rasmussen, Conroe, TX (US); Bruce T. Kelley, Kingwood, TX (US); Stanley O. Uptigrove, The Woodlands, TX (US)

(21) Appl. No.: 13/122,336

(22) PCT Filed: Aug. 19, 2009
(86) PCT No.: PCT/US09/54316

§ 371 Date: Apr. 1, 2011

Related U.S. Application Data
(60) Provisional application No. 61/113,942, filed on Nov. 12, 2008.

(51) Int. Cl. F17D 3/00

(52) U.S. Cl. 137/565.01

(57) ABSTRACT

The present invention discloses apparatuses, systems, and methods for utilizing oil-free gas in a gas processing system. In some embodiments, an oil-free or “dry” gas is provided by a gas source to an oil-free compressor, such as a dry seal compressor, which charges a receiver vessel or vessels, which then provides the oil-free gas to at least one piece of processing equipment, such as an injection compressor or compressors for use in EOR, carbon sequestration, sour gas injection, or other gas handling operations. The methods and systems may include a controller for charging the receiver vessel when the pressure in the vessel decreases below a low pressure threshold and reducing the charging flow rate when the pressure in the vessel meets or exceeds a high pressure threshold in the vessel, thereby maintaining an operational pressure in the vessel.

### CROSS REFERENCE TO RELATED APPLICATIONS

This application claims the benefit of U.S. Provisional Application No. 61/113,942, filed 12 Nov. 2008.

### FIELD OF THE INVENTION

This invention relates generally to methods and systems for operating a vessel compressor system. More particularly, this invention relates to a system, apparatus, and associated methods of providing and utilizing high pressure oil-free gas.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Environmentally conscious and efficient recovery of oil and gas from hydrocarbon reservoirs is a multidimensional problem that has become one of the world's toughest energy challenges. Injection of various gasses into such reservoirs is now utilized for sequestration, pressure maintenance, or enhanced oil recovery operations. In recent years, injection compressor technology has advanced to the point that development plans for some oil and gas fields incorporate them to inject acid or sour gas in underground formations for sequestration or enhanced oil recovery (EOR) operations. The compressor shafts are typically sealed using dry gas seals (DGS) which utilize the principle of sealing between a stationary face against a rotating face by using a gas fluid film. This “seal gas” provides the lubrication and cooling properties needed by the seal for long and reliable operation. Seal gas should be free of particulates, liquids, and physical properties that cause condensation of the seal gas when expanded across the seal faces.

Typically, dry seal compressors pressurize injection gas streams (e.g. acid or sour gas streams) to pressures in excess of about 4,000 pounds per square inch absolute (psia) with stream flow rates in excess of 100 million standard cubic feet per day (Mscfd). To operate without failure, the seals in the compressors should be lubricated with a gas stream that will not condense a liquid phase as its pressure drops when it expands across the seal faces. The seal gas pressure is greater than the compressor suction pressure, but less than the compressor discharge pressure.

One strategy for producing a non-condensing seal gas is to compress a purified low pressure (e.g. less than about 800 psia) methane or nitrogen stream in a reciprocating compressor. Reciprocating compressors are lubricated with cylinder oil that has some miscibility with the gas, especially at high (e.g. greater than about 2,000 psia) pressures. After compression, the gas stream contains oil in the form of either vapor or entrained droplets. The vapor generally can not be filtered out and at high pressures filtration of entrained droplets is typically inefficient. Thus the oil in the high pressure methane stream will have a liquid phase that is either entrained or “drops out” of the gas when the pressure is dropped through the seals or at pressure regulators that control the pressure to the seals. This cylinder oil “carry-over” into the seal gas is expected to damage and cause premature failure of standard dry seal compressors, resulting in significant down-time and lost production.

Connecting a dry seal centrifugal compressor directly to the dry seals is also problematic because the minimum flow rate from current commercially available centrifugal compressors with the requisite head exceeds the seal gas flow required for most high pressure compressors.

Hence, an improved method of providing oil free seal gas for use in dry seals is needed.

### SUMMARY

One embodiment of the present invention discloses a system of controlling liquid impacts. The system includes an oil-free gas source configured to provide an oil-free gas, wherein the oil-free gas is substantially free of air and oxygen; an oil-free compressor configured to compress the oil-free gas to a pressure greater than about 150 bar to form a high pressure oil-free gas stream; a receiver vessel configured to receive the high pressure oil-free gas stream from the oil-free compressor at a charging flow rate, hold the gas at an operational pressure, and discharge the oil-free gas at a discharge flow rate for use in at least one piece of processing equipment. In at least one embodiment, the system further includes a controller configured to increase the charging flow rate to be greater than the discharge flow rate when the operational pressure in the receiver vessel drops below a low pressure threshold and decrease the charging flow rate to be less than the discharge flow rate when the operational pressure in the receiver vessel increases above a high pressure threshold.

Another embodiment of the present invention discloses a method of utilizing oil-free gas, wherein the oil-free gas is substantially free of air and oxygen. The method includes compressing an oil-free gas stream in an oil-free compressor to a pressure greater than about 150 bar to form a high pressure oil-free gas stream; receiving the high pressure oil-free gas stream in a receiver vessel at a charging flow rate; holding the compressed oil-free gas at an operational pressure; and discharging the oil-free gas at a discharge flow rate for use in at least one piece of processing equipment. In at least one embodiment, the method further includes controlling the oil-free compressor with a controller. The controlling step includes: i) increasing the charging flow rate above the discharge flow rate when the operational pressure in the receiver vessel drops below a low pressure threshold; and ii) decreasing the charging flow rate to be less than the discharge flow rate when the operational pressure in the receiver vessel increases above a high pressure threshold.

### BRIEF DESCRIPTION OF THE DRAWINGS

The foregoing and other advantages of the present techniques may become apparent upon reviewing the following detailed description and drawings in which:

FIG. 1 is a schematic of an exemplary system of the present disclosure;

FIG. 2 is an illustration of a flow chart of an exemplary method of operating an oil-free gas utilization system as shown in FIG. 1;

FIG. 3 is an illustration of an exemplary embodiment of a gas processing system including the oil-free gas utilization system of FIG. 1 and the methods of FIG. 2;

FIG. 4 is an illustration of a graph showing the pressure cycle described in the provided exemplary case;

FIG. 5 is an illustration of a graph projecting configurations for the exemplary case set forth in FIG. 4.

### DETAILED DESCRIPTION

In the following detailed description section, some specific embodiments of the present disclosure are described in connection with preferred embodiments. However, to the extent that the following description is specific to a particular embodiment or a particular use of the presently disclosed technology, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

The term “oil-free gas,” as used in this application, means a gaseous substance or mixture of gaseous substances that is nearly completely free of oil and other liquid components, such as some heavy hydrocarbons, at operating conditions, such as, for example having less than about 0.1 weight percent (wt %) oil, less than about 0.01 wt % oil, less than about 0.001 wt % oil, or even less than about 0.0001 wt % oil. Note that the term “oil-free gas” is used for convenience and emphasis on the problem of oil droplets entrained in gas streams, but as used in this application is interchangeable with the term “dry gas.”

The term “oil-free compressor,” as used in this application, means a compressor utilizing an “oil-free gas seal” or “dry gas seal” rather than an oil seal, so there is no oil contamination of the gas being compressed. Note that the oil-free compressor may or may not have oil lubricated bearings, couplings or gears.

In one embodiment, oil-free seal gas for use in dry seals is provided by a centrifugal compressor which charges a high pressure receiver vessel. Discharge from such a compressor is oil-free. A compressor may be selected that is commercially available with as low a flow rate as possible with sufficient head to deliver the gas at the required pressure. Outlet flow from the receiver vessel is regulated to meet the requirements of any downstream equipment. Such an arrangement would beneficially allow efficient operation of the centrifugal compressor and permit uninterrupted operation of the dry gas seals.

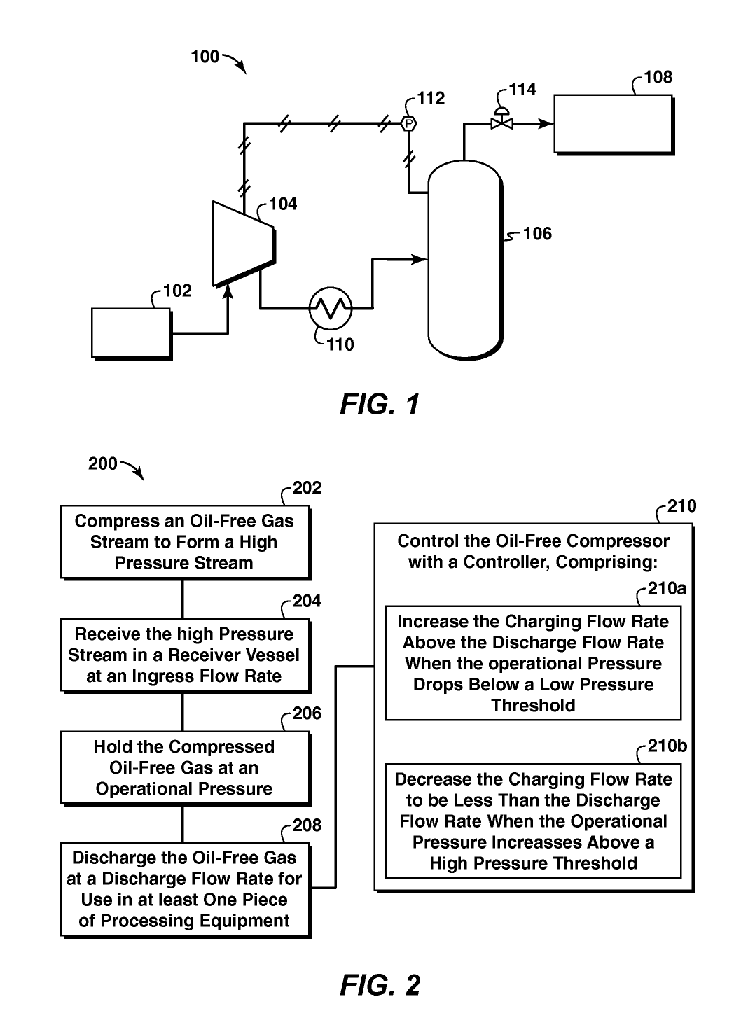

Referring now to the figures, FIG. 1 is a schematic of an exemplary system of the present disclosure. The system 100 includes an oil-free gas source 102, which feeds to an oil-free compressor 104. The discharge from the compressor 104 is a high pressure oil-free gas stream, which is fed to a receiver vessel 106, which is configured to hold the gas, then discharge the gas to at least one piece of processing equipment 108. The system further includes optional equipment such as a cooler 110 for decreasing the temperature of the high pressure oil-free gas stream, a controller 112 for controlling operation of the compressor 104 based on the operational pressure in the receiver vessel 106, and a valve 114 for controlling the flow of discharge gas from the receiver vessel 106 to the at least one piece of processing equipment 108.

The oil-free gas source 102 may be comprised of a fuel gas, such as methane, acid gas, flue gas, nitrogen, carbon dioxide, other gases, and any combination thereof, depending on the quantity and type of gas available. In fact, a person of ordinary skill in the art will recognize that the only limitation on the type of gas used, is that the gas be “dry.” This means that the gas will not include any liquid components such as oil, liquid hydrocarbons, water, or other liquids, either entrained in the gas stream or as vapor in the gas stream. Tolerable amounts of liquids in the gas stream may include less than about 0.1 weight percent (wt %) liquid components, less than about 0.01 wt % liquid components, 0.001 wt % liquid components, or less than about 0.0001 wt % liquid components. In addition, in one or more embodiments of the present invention, the gas may be substantially free of oxygen and/or air. In such an embodiment, tolerable amounts of air and/or oxygen in the gas stream may include less than about 0.1 weight percent (wt %) total of air and/or oxygen, less than about 0.01 wt % total of air and/or oxygen, 0.001 wt % total of air and/or oxygen, or less than about 0.0001 wt % total of air and/or oxygen.

The compressor 104 may be any type of gas compressor, so long as it does not add any oil or other liquids to the gas stream being compressed. Examples of suitable compressors include a centrifugal compressor, an axial flow compressor, a dry screw compressor, and an oil-free reciprocating compressor. The selected compressor is preferably a commercially available compressor with as low a flow rate as possible with sufficient head to deliver the gas at the required pressure to meet cost, space, and performance requirements while also beneficially providing greater flexibility than the prior art solutions to seal gas problems. In some embodiments, multiple compressors may be used in series, in parallel, or in different portions of an overall gas handling system, depending on the particular requirements of such a system.

The receiver vessel 106 may be any reasonable shape and size suitable for the volumes and pressures of gases required for the particular system utilizing embodiments of the present disclosure. In one exemplary embodiment, multiple vessels may be utilized, including from one to ten vessels or more per compressor, depending on the gas rate and desired number of starts per hour. In general, the flow rate of gas from the compressor or compressors (e.g. charging rate) will exceed the flow rate required to operate the gas seals (e.g. discharge rate), so when the operational pressure in the receiver vessel meets or exceeds a pre-determined threshold, the flow of gas into the vessel is preferably lowered to below the discharge flow rate to avoid damaging the vessel.

In some exemplary cases, the receiver vessel 106 may be a composite vessel capable of receiving and holding sour gas, acid gas, fuel gas, and any other type of gas that may come from the oil-free gas source 102. The vessel 106 may further be configured to operate at pressures up to at least about 250 bara, up to about 350 bara, up to about 450, or up to about 550 bar. Depending on the needs of the system 100, it may be desirable to utilize a receiver vessel 106 that is commercially available.

The at least one piece of processing equipment 108 may be any type of equipment or portion of equipment that utilizes pressurized oil-free or “dry” gas. One exemplary application is a dry gas seal in an oil-free compressor, such as compressor 104. The processing equipment may include multiple compressors, such as injection compressors, the oil-free compressor 104, a booster compressor for compressing used process gas, or any other compressor utilizing oil-free gas.

The optional cooler 110 may be any type of cooler for cooling a gaseous stream, such as a counter flow or concurrent flow heat exchanger, which may utilize ambient air, liquefied natural gas, atmospheric water, subterranean water, standard coolants, or other sources to remove heat energy from the compressed oil-free gas stream. The temperature reduction is preferably significant enough to provide an efficient process, but utilize as little additional energy as possible.

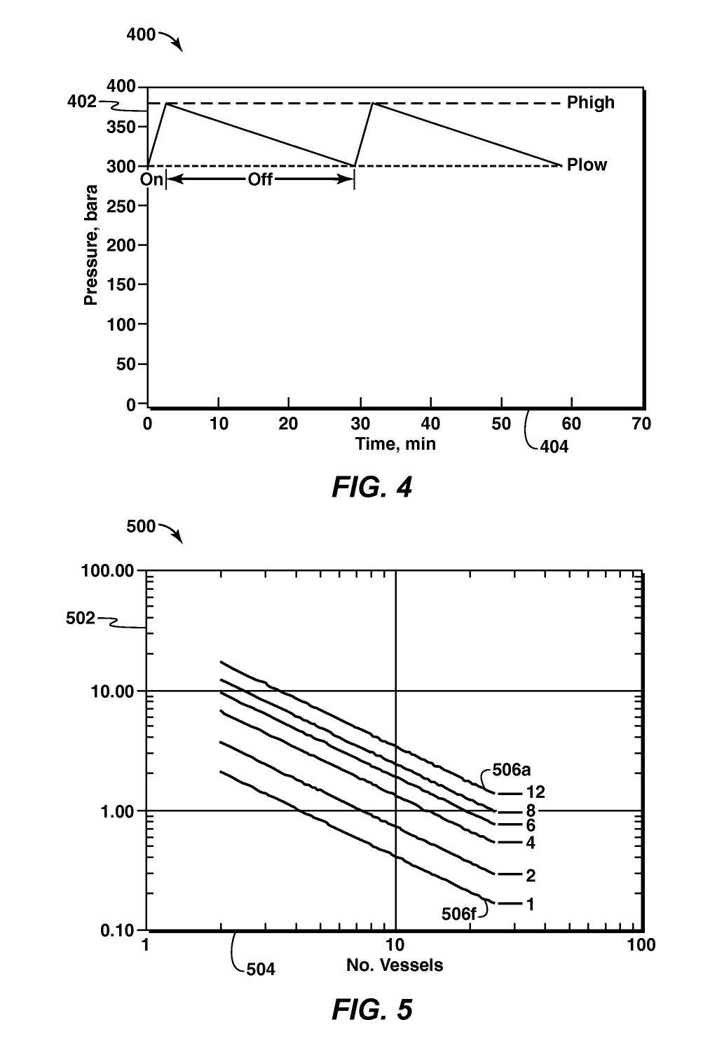

The optional controller 112 may be configured to adjust the charging flow rate in response to the pressure in the receiver vessel 106 and the discharge flow rate. In most cases, the charging flow rate will be greater than the discharge flow rate for a period of time until the receiver vessel is fully charged, at which time the controller 112 will reduce the charging flow rate. This charging pattern is shown in combination with a specific example below in FIG. 4. Control of the charging flow rate may be done by any reasonable means, such as by turning off the oil-free compressor 104, varying a compressor recycle, diverting at least a portion of the high pressure oil-free gas stream away from the receiver vessel, and any combination thereof. A person of ordinary skill in the art will recognize that many types of controllers and control systems may be utilized, including automatic control systems, manual control systems, automatic control with manual overrides, computerized control, emergency shutoff controls, and any combination thereof.

The valve 114 may be any type of valve capable of handling the pressures from the receiver vessel 106 and compositions of gases from the oil-free gas source 102. In some cases, the valve may be a combination of valves, may include redundant valves, may be controlled via the controller 112, may be integrated into the outer shell of the receiver vessel 106, and any combination thereof.

FIG. 2 is an illustration of a flow chart of an exemplary method of operating an oil-free gas utilization system as shown in FIG. 1. As such, FIG. 2 may be best understood with reference to FIG. 1. The method 200 begins at box 202 with the step of compressing an oil-free gas stream in an oil-free compressor 104 to a pressure greater than about 150 bar to form a high pressure oil-free gas stream. Box 204 shows the step of receiving the high pressure oil-free gas stream in a receiver vessel 106 at a charging flow rate, then box 206 shows holding the compressed oil-free gas at an operational pressure, and box 208 shows discharging the oil-free gas at a discharge flow rate for use in at least one piece of processing equipment 108. Box 210 shows the optional step of controlling the operation of the oil-free compressor 104 with a controller 112, including the steps of box 210a of increasing the charging flow rate above the discharge flow rate when the operational pressure in the receiver vessel drops below a low pressure threshold and box 210b of decreasing the charging flow rate to be less than the discharge flow rate when the operational pressure in the receiver vessel increases above a high pressure threshold.

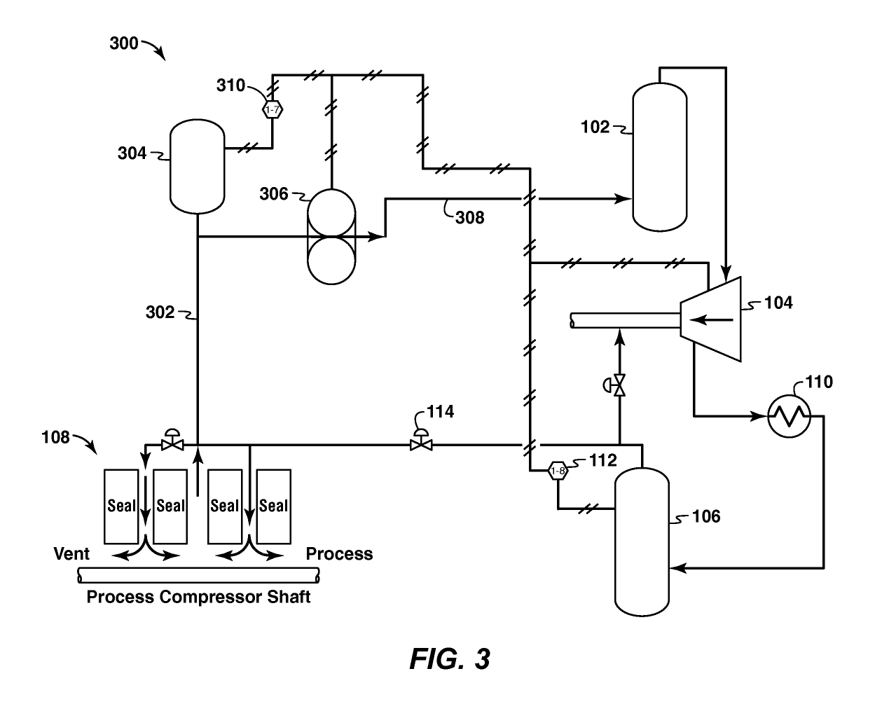

FIG. 3 is an illustration of an exemplary embodiment of a gas processing system including the oil-free gas utilization system of FIG. 1 and the methods of FIG. 2. As such, FIG. 3 may be best understood with reference to FIGS. 1 and 2. The system 300 includes all of the components from FIG. 1, but in a more particular arrangement. For example, the at least one piece of processing equipment 108 is a process compressor in system 300, which includes dry gas seals on a process compressor shaft having a vent side and a process side, wherein the dry gas seals are fed by the oil-free gas stream from the receiver vessel 106 via the valve 114. The dry seal system may further include other valves for fine tuned control of the seal gas flow.

Stream 302 is an intermediate seal gas bleed stream from the process compressor 108, which is received by a seal suction bottle 304 for intermediate storage and is then compressed by an intermediate oil-free compressor 306 to form a pressurized intermediate seal gas stream 308, which is fed to the oil-free gas source 102. The system 300 further includes an optional controller 310 for controlling either or both of the intermediate oil-free compressor 306 and the oil-free compressor 104 based on an operating pressure in the seal suction bottle 304.

In one exemplary embodiment, there may be another seal gas bleed from the dry seals of the oil-free compressor 104, which may be fed to seal suction bottle 304 or another seal suction bottle (not shown). This additional stream may be handled in the same or similar fashion as stream 302 and may even be combined with stream 308.

Stream 302 will generally be at a significantly lower pressure than the incoming high pressure oil-free gas stream, but should still be essentially oil-free. For example, stream 302 may be from about 4 bara to about 20 bara, depending on the operational requirements of the process compressor 108. Seal suction bottle 304 may be smaller and includes lower pressure handling requirements than the receiver vessel 106, but is preferably a separate vessel, due to the different requirements.

Intermediate oil-free compressor 306 may be any type of oil-free compressor, but a single or tandem dry screw compressor is preferred in one exemplary embodiment, depending on the pressure from stream 302. Preferably, the compressor 306 compresses the gas to at least about 30 bara, at least about 40 bara, or at least about 60 bara. The specific boost pressure may be determined based on the requirements of the system, availability of commercial compressors 306, and the pressure of the oil-free gas source vessel 102.

### Examples

In one exemplary case, the minimum flow rate may be about 800 to 1,500 acfm (about 45 Mscfd to 90 Mscfd) for a centrifugal compressor 106 providing a pressure increase from 40 bara (e.g., in the oil-free gas source 102) to 380 bara for high pressure seal gas. The at least one piece of processing equipment 108 is a high pressure sour gas injection compressor having six dry gas seals and requiring a total seal gas flow rate of about 4 Mscfd when the seals are in the worn condition. In this example, the receiver vessel charging rate is 10 or more times the receiver vessel discharge rate. When the seal gas compressor 104 is on, inlet flow to the receiver vessel 106 exceeds the outlet flow 210a causing the pressure in the receiver vessel 106 to rise. At some predetermined high pressure threshold in the receiver vessel 106 (e.g., 380 bara), inlet flow from the seal gas compressor 104 is stopped 210b (e.g., the seal gas compressor is turned off or diverted), but the receiver vessel 106 continues to provide discharge flow. With flow leaving the receiver vessel 106 and none entering, the receiver vessel pressure drops. At some predetermined low pressure threshold in the receiver vessel 106 (e.g., 300 bara), inlet flow from the seal gas compressor 104 is started (e.g., the seal gas compressor is turned on or flow is diverted back to the receiver vessel).

FIG. 4 is an illustration of a graph showing the pressure cycle described in the exemplary case discussed above. As such, FIG. 4 may be best understood with reference to FIGS. 1 and 2. The graph 400 shows pressure in bara 402 versus time in minutes 404. In the present example, the cycle results in a pressure graph having a short charging time and a notably longer discharging time. However, a person of ordinary skill in the art will recognize that the addition of other processing equipment 108, other compressors 104, additional receiver vessels 106, a seal suction bottle 304, and other equipment would be expected to generate a significantly different pressure cycle graph.

FIG. 5 is an illustration of a graph projecting configurations for the exemplary case set forth in FIG. 4. As such, FIG. 5 may be best understood with reference to FIG. 4. The graph 500 shows the number of starts per hour 502 on a log scale versus the number of receiver vessels 504 on a log scale. The plots 506a-506f show the flow rate of gas from the gas source 102 to the oil-free compressor 104 in million standard cubic feet per day (Mscfd).

The same operational pressure range of 300 bara to 380 bara is assumed for this example. The receiver vessels 106 are composite or carbon composite vessels and may have a maximum pressure rating above 400 bara and a volume of from about 7-10 cubic meters (m³) (e.g. about 1 meter (m) in diameter and about 10 m long). The flow rates 506a-506f will depend on the number of process compressors 108 and the wear state of the process compressors 108. For example, one sour gas injection (SGI) compressor will require about 2.4 Mscfd (e.g. about plot 506e) in the normal state and about 4 Mscfd (e.g. plot 506d) in the worn state. In another example, three SGI compressors 108 result in a seal flow rate of about 7.8 Mscfd (e.g. about plot 506b) in the normal state and about 12 Mscfd (e.g. plot 506a) in the worn state. Clearly, flow rates will vary depending on at least the number of compressors 108 online, the wear state of the seals (which will not change in a step-wise manner), and the type of compressors 108 used. As shown in the graph 500, if the desire is to have one start per hour per compressor, the three SGI compressor case would require 11 receiver vessels for normal conditions and 18 vessels for worn conditions. A person of ordinary skill in the art will recognize that a nearly infinite number of combinations are possible and this chart and these examples are merely illustrations of specific embodiments of the presently described methods and systems.

### ADDITIONAL APPLICATIONS

In addition to providing dry gas, the concepts described can be used for seal gas for other applications including: capacitance (storage) of seal gas for abnormal (usually transient) operations; startup; rundown; staged de-pressuring; settle out; closed loop refrigeration (also to capture the refrigerant leaking across the seal with the storage drum at low pressure until enough gas has accumulated to boost it back up into the suction side of the compressor); carbon sequestration, enhanced oil recovery (EOR), and toxic gas handling, in addition to other processes know to those of skill in the art.

While the present disclosure of the invention may be susceptible to various modifications and alternative forms, the exemplary embodiments discussed above have been shown only by way of example. However, it should again be understood that the invention is not intended to be limited to the particular embodiments disclosed herein. Indeed, the present disclosure of the invention includes all alternatives, modifications, and equivalents falling within the true spirit and scope of the invention as defined by the following appended claims.

What is claimed is:

1. A system for providing high pressure oil-free gas, comprising:
an oil-free gas source configured to provide an oil-free gas wherein the oil-free gas is substantially free of air and oxygen;
an oil-free compressor configured to compress the oil-free gas to a pressure greater than about 150 bar to form a high pressure oil-free gas stream;
a receiver vessel configured to receive the high pressure oil-free gas stream from the oil-free compressor at a charging flow rate, hold the gas at an operational pressure, and discharge the oil-free gas at a discharge flow rate for use in at least one piece of processing equipment.

2. The system of claim 1, further comprising a controller configured to increase the charging flow rate to be greater than the discharge flow rate when the operational pressure in the receiver vessel drops below a low pressure threshold and decrease the charging flow rate to be less than the discharge flow rate when the operational pressure in the receiver vessel increases above a high pressure threshold.

3. The system of claim 2, wherein the controller is further configured to increase the charging flow rate by controlling a feature selected from the group consisting of: turning on the oil-free compressor, varying a compressor recycle, and any combination thereof.

4. The system of claim 2, wherein the controller is further configured to decrease the charging flow rate by controlling a feature selected from the group consisting of: turning off the oil-free compressor, varying a compressor recycle, diverting at least a portion of the high pressure oil-free gas stream away from the receiver vessel, and any combination thereof.

5. The system of claim 2, wherein the oil-free compressor is selected from the group consisting of a dry screw compressor, and an oil-free reciprocating compressor.

6. The system of claim 2, wherein the oil-free compressor is selected from the group consisting of a centrifugal compressor and an axial flow compressor.

7. The system of claim 2, wherein the oil-free gas source is selected from the group consisting of a fuel gas, a process gas, an acid gas, an inert gas, and any combination thereof.

8. The system of claim 2, further comprising a cooler configured to decrease the temperature of the high pressure oil-free gas stream.

9. The system of claim 2, wherein the at least one piece of processing equipment is selected from the group consisting of the oil-free compressor, a main compressor, a process compressor, and any combination thereof.

10. The system of claim 2, wherein the discharged high pressure oil-free gas stream is utilized in a gas seal in the at least one piece of processing equipment.

11. The system of claim 1, wherein the high pressure oil-free gas stream is compressed to a pressure greater than about 300 bar, and the operating pressure is between the low pressure threshold of about 250 bar and the high pressure threshold of about 450 bar.

12. The system of claim 2, further comprising:
an intermediate seal gas bleed stream from the at least one piece of processing equipment;
a seal suction bottle configured to receive the intermediate seal gas bleed stream; and
an intermediate oil-free compressor configured to increase the pressure of the intermediate seal gas bleed stream to form a pressurized intermediate seal gas stream.

13. A method of utilizing oil-free gas, wherein the oil-free gas is substantially free of air and oxygen, comprising:
compressing an oil-free gas stream in an oil-free compressor to a pressure greater than about 150 bar to form a high pressure oil-free gas stream;
receiving the high pressure oil-free gas stream in a receiver vessel at a charging flow rate;
holding the compressed oil-free gas at an operational pressure; and
discharging the oil-free gas at a discharge flow rate for use in at least one piece of processing equipment.

14. The method of claim 13, further comprising:
controlling the oil-free compressor with a controller, comprising:
i) increasing the charging flow rate above the discharge flow rate when the operational pressure in the receiver vessel drops below a low pressure threshold; and
ii) decreasing the charging flow rate to be less than the discharge flow rate when the operational pressure in the receiver vessel increases above a high pressure threshold.

15. The method of claim 14, wherein the controller increases the charging flow rate by controlling a feature selected from the group consisting of: turning on the oil-free compressor, varying a compressor recycle, and any combination thereof.

16. The method of claim 14, wherein the controller decreases the charging flow rate by controlling a feature selected from the group consisting of: turning off the oil-free compressor, varying a compressor recycle, diverting at least a portion of the high pressure oil-free gas stream away from the receiver vessel, and any combination thereof.

17. The method of claim 14, wherein the oil-free compressor is selected from the group consisting of a dry screw compressor, and an oil-free reciprocating compressor.

18. The method of claim 14, wherein the oil-free compressor is selected from the group consisting of a centrifugal compressor, and an axial flow compressor.

19. The method of claim 14, wherein the oil-free gas source is selected from the group consisting of a fuel gas, a process gas, an acid gas, an inert gas, and any combination thereof.

20. The method of claim 14, further comprising a cooler configured to decrease the temperature of the high pressure oil-free gas stream.

21. The method of claim 14, wherein the at least one piece of processing equipment is selected from the group consisting of the oil-free compressor, a main compressor, a process compressor, and any combination thereof.

22. The method of claim 14, wherein the discharged high pressure oil-free gas stream is utilized in a gas seal in the at least one piece of processing equipment.

23. The method of claim 14, wherein the high pressure oil-free gas stream is compressed to a pressure greater than about 300 bar, and the operating pressure is between the low pressure threshold of about 250 bar and the high pressure threshold of about 450 bar.

24. The method of claim 14, further comprising:
capturing an intermediate seal gas bleed stream from the at least one piece of processing equipment in a seal suction bottle; and
increasing the pressure of the intermediate seal gas bleed stream in an intermediate oil-free compressor to form a pressurized intermediate seal gas stream.
